(19) United States
(12) Patent Application Publication
(10) Pub. No.: US 2024/0176843 A1
(43) Pub. Date: May 30, 2024

(54) SOLVING SYSTEMS OF LINEAR EQUATIONS USING MIXED PRECISION

(71) Applicant: International Business Machines Corporation, Armonk, NY (US)

(72) Inventors: Tayfun Gokmen, Briarcliff Manor, NY (US); Vasileios Kalantzis, White Plains, NY (US); Shashanka Ubaru, Ossining, NY (US); Lior Horesh, North Salem, NY (US)

(21) Appl. No.: 18/179,411

(22) Filed: Mar. 7, 2023

(30) Foreign Application Priority Data
Nov. 30, 2022 (GR) 20220100984

(51) Int. Cl. G06F 17/12

(52) U.S. Cl. CPC G06F 17/12

(57) ABSTRACT

A method of computation includes receiving, by a requesting device, a system of linear equations, and computing a solution to the system of linear equations by a flexible iterative algorithm. The computing includes, for each iteration, determining a most computationally expensive operation of the iteration, mapping the most expensive operation to a low precision format, performing the most expensive operation according to a low precision, performing other operations of the iteration according to a high precision, and returning the solution to the requesting device.

### BACKGROUND

The present invention generally relates to computer technology, specifically, to systems and methods for solving systems of linear equations.

Mixed precision computing has become more popular, particularly with the advent and advancements in machine learning and artificial intelligence (AI). For example, reduced precision 8-bit floating point (FP8) representations have been used to train deep neural networks (DNN) and other learning models. Reduced precision hardware provides benefits including resilience to noisy computation, but does come with a number of challenges.

### SUMMARY

One or more embodiments of the present invention are directed to a method of computation. The method includes receiving, by a requesting device, a system of linear equations, and computing a solution to the system of linear equations by a flexible iterative algorithm. The computing includes, for each iteration, determining a most computationally expensive operation of the iteration, mapping the most expensive operation to a low precision format, performing the most expensive operation according to a low precision, performing other operations of the iteration according to a high precision, and returning the solution to the requesting device.

One or more embodiments of the present invention are directed to a system that includes a memory device and one or more processing units coupled with the memory device, the one or more processing units configured to perform a method of computation. The method includes receiving, by a requesting device, a system of linear equations, and computing a solution to the system of linear equations by a flexible iterative algorithm. The computing includes, for each iteration, determining a most computationally expensive operation of the iteration, mapping the most expensive operation to a low precision format, performing the most expensive operation according to a low precision, performing other operations of the iteration according to a high precision, and returning the solution to the requesting device.

One or more embodiments of the present invention are directed to a computer program product comprising a computer-readable memory that has computer-executable instructions stored thereupon, the computer-executable instructions when executed by a processor cause the processor to perform operations. The operations include receiving, by a requesting device, a system of linear equations, and computing a solution to the system of linear equations by a flexible iterative algorithm. The computing includes, for each iteration, determining a most computationally expensive operation of the iteration, mapping the most expensive operation to a low precision format, performing the most expensive operation according to a low precision, performing other operations of the iteration according to a high precision, and returning the solution to the requesting device.

Other embodiments of the present invention implement features of the above-described methods in systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a computer system for performing aspects of one or more embodiments of the present invention;

FIG. 2 depicts a solver for computing solutions to systems of linear equations, including high precision and low precision hardware, in accordance with one or more embodiments of the present invention;

FIG. 3 depicts a flowchart of a method of solving systems of linear equations, according to one or more embodiments of the present invention; and

FIGS. 4A and 4B depict examples of results related to solutions to a system of linear equations.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

One or more embodiments of the present invention are directed to devices, systems, and methods for linear algebra computation. An embodiment of a method includes receiving a request to solve a system of linear equations (e.g., as part of a machine learning training operation). A processing device such as a solver is configured to solve the system of linear equations using an iterative algorithm (e.g., a flexible algorithm such as flexible GMRES), in conjunction with a mixed precision system that includes high precision hardware and low precision hardware. In an embodiment, the method includes determining a most computationally expensive operation, which may be a preconditioning operation. The system is solved by performing the most expensive operation in each iteration using a low precision, and performing other operations using the high precision. For example, the solver performs each iteration by preconditioning at a low precision and performing the other operations using the high precision.

One or more embodiments of the present invention are rooted in computing technology, and provide improvements to computing technology, particularly, data analysis and machine learning/artificial intelligences. For example, the embodiments described herein improve computation by utilizing reduced precision hardware in such a manner that computation results are indistinguishable from results produced by higher precision hardware. Accordingly, the embodiments provide for increased speed and reduced energy consumption without sacrificing computational precision.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

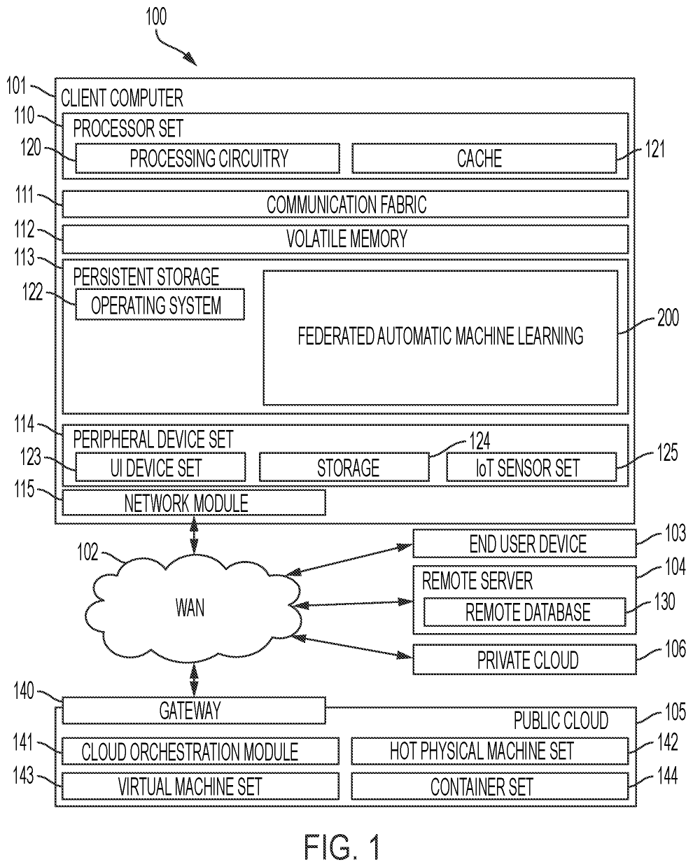

Referring now to FIG. 1, computing environment 100 contains an example of an environment for the execution of at least some of the computer code involved in performing the inventive methods, such as federated automatic machine learning 200 (referred to herein as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

In an embodiment, the computing environment 100 is configured to solve systems of linear equations using an iterative process, in which a solution is approximated using previous results until a solution having an acceptable precision is reached. The computing environment may use various iterative methods, such as a Conjugate Gradient (CG) method, a Minimum Residual (MINRES) method and a Quasi-minimal Residual (QMR) method. In an embodiment, the computing environment 100 is configured to solve using a Generalized Minimal Residual (GMRES) method (e.g., for sparse linear systems where A can be non-symmetric and indefinite). In an embodiment, the iterative method is performed using a flexible iterative algorithm, such as a flexible GMRES algorithm.

The computing environment 100, in an embodiment, includes a mixed precision computing system for solving systems of linear equations, so that computations can be performed using different precisions. The environment 100 allows higher cost computations to be performed at a lower precision, to save time and resources.

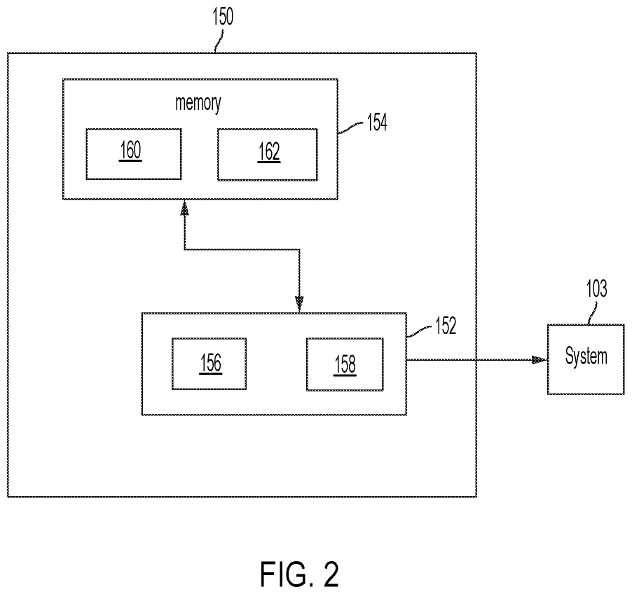

FIG. 2 depicts portions of an embodiment of the computing environment 100. The client computer 101 (or other processing device or system) includes a computation system or solving system (solver) 150, which includes one or more processors 152 (e.g., as part of the processor set 110). The processor(s) 152 function as a controller and are connected to memory 154. The one or more processors 152 (also referred to as a controller 152) are configured to perform computations with different precisions. For example, the controller 152 includes high precision hardware including a high precision engine 156, and low precision hardware including a low precision engine 158.

The high precision may perform operations using various precisions, such as a 16-bit precision (using a floating point (FP) format referred to as FP16), a 32-bit precision (using a format referred to as FP32), and/or a 64-bit precision (using a format referred to as FP64). The low precision hardware may perform operations using one or more precisions that are reduced as compared to the high precision, such as a 4-bit precision (using a format referred to as FP4) and/or an 8-bit precision (using a format referred to as FP8).

As discussed further below, the controller 152 solves systems of systems of linear equations using the different precision hardware, in order to perform expensive computations using the low precision engine 158 and perform other computations using the high precision engine 156. To this end, the memory 154 may include constituent memory spaces or partitions for storing data using selected floating point formats. For example, a low precision memory 160 is used to store data (e.g., preconditioning matrices) in a low precision format such as FP8, and a high precision memory 162 is used to store high precision data (e.g., matrices, vectors, iteration results, solutions, etc.) in a high precision format such as FP32 or FP64.

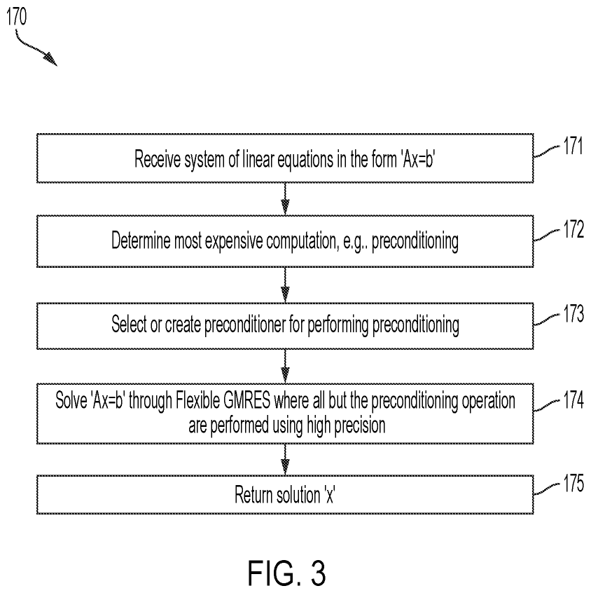

FIG. 3 depicts a flowchart of an embodiment of a method 170 of solving a system of linear equations. The method 170 includes a number of steps or stages represented by blocks 171-175. It is noted that the method may include all of the steps or stages or fewer than all of the steps or stages.

The method 170 may be performed by any suitable computing device or system. For example, the method can be performed by the computer 101, the processor set 110 and/or the end user device 103. The method 170 is discussed in conjunction with the solver 152 for illustration purposes.

At block 171, a linear algebraic problem is received as part of a computing operation. For example, the problem may be part of a training process for training a machine learning model such as a DNN. The problem is a system of equations in the form of a matrix equation Ax=b, where A is a matrix, b is a vector, and x is a solution vector.

At block 172, the solver 152 determines, for each iteration, the most computationally expensive computation. In an embodiment, the most computationally expensive computation is the preconditioning operation.

At block 173, a preconditioner is selected that is used as part of the iterative process and is used for the preconditioning operation. For example, a preconditioner is created and mapped to low precision (e.g., FP8) hardware, such as the low precision engine 158 of FIG. 2. The preconditioner includes, for example, an approximate inverse preconditioner that multiples both sides of the system of equations by a matrix M⁻¹ (which is some kind of approximation of A⁻¹). The preconditioner is not limited to an approximate inverse preconditioner, and may be any suitable type of preconditioner (e.g., factorization, over-relaxation, etc.) or combination of preconditioners.

In an embodiment, the iterative process is a flexible iterative algorithm, in which the preconditioning operation can be varied among one or more iterations to adjust for any inaccuracies introduced due to previous iterations using the low precision of the preconditioner. The preconditioning operation may be varied by using the same type of preconditioner with different parameters (e.g., different relaxation parameters. For example, the matrix M⁻¹ may be varied among one or more iterations by varying the approximation of A⁻¹. Additionally, or alternatively, the preconditioning operation may be varied by applying different types of preconditioners.

At block 174, the problem is solved using an iterative method, such as the flexible GMRES algorithm. Within each iteration, the preconditioning operation (or other most expensive operation) is performed using the low precision. In each iteration, the matrix equation Ax=b is solved using a varying coefficient matrix A and vector b. Iterations are repeated until the solution vector x converges to a desired degree of precision.

For example, the matrix equation is solved using the flexible GMRES algorithm, in which the preconditioning operation in each iteration is performed with an 8-bit precision (using FP8 format). The other operations are performed at a high precision. For example, the other operations are performed using 16-bit precision (FP16 format), using single (e.g., 32-bit) precision (FP32 format) and/or using double (e.g., 64-bit) precision (FP64 format).

At block 175, the solution x is returned to the requesting device or system. For example, the solution x at a desired precision is output to a requesting device or system, such as the end user device 103.

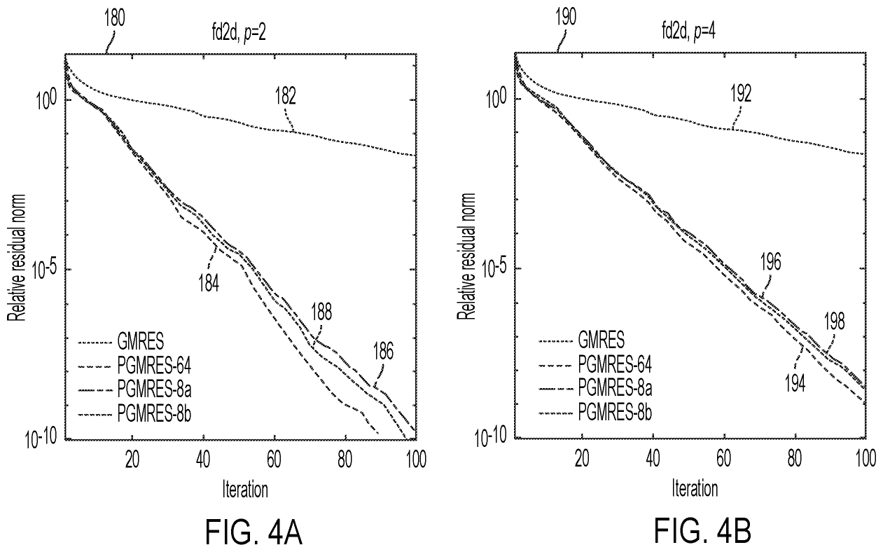

FIGS. 4A and 4B depict results of operations performed to solve a system of two-dimensional linear equations using the flexible GMRES algorithm. The examples illustrate the effects of using a preconditioner according to existing methods, as compared to the effects of using a low precision for preconditioning according to embodiments described herein.

FIG. 4A includes a graph 180 showing the relative residual norm calculated by using a two-dimensional finite difference method (fd2d) with 2 variables, and FIG. 4B includes a graph 190 showing the relative residual norm calculated by using a fd2d method with 4 variables. A solution was computed using GMRES with no preconditioning, and with preconditioning using different precisions.

Referring to FIG. 4A, the system was solved using GMRES with no preconditioning and the residual norm for each iteration is shown by curve 182 (GMRES curve). Curve 184 (PGMRES-64) shows the relative residual norm for a solution computed with preconditioning and subsequent computations in each iteration performed at a high precision (64-bit). Curve 186 (PGMRES-8a) shows the relative residual norm for a solution computed with preconditioning performed using 8-bit precision and a FP8 format of (1,5,2), and other computations in each iteration performed at 64-bit precision. Curve 188 (PGMRES-8b) shows the relative residual norm for a solution computed with preconditioning performed using 8-bit precision and a FP8 format of (1,4,3), and other computations in each iteration performed at 64-bit precision.

Referring to FIG. 4B, the system was solved using GMRES with no preconditioning and the residual norm is shown by curve 192. Curve 194 shows the relative residual norm for a solution computed with preconditioning and subsequent computations in each iteration performed at 64-bit precision. Curve 196 shows the relative residual norm for a solution computed with preconditioning using 8-bit precision and the (1,5,2) format, and other computations performed at 64-bit precision. Curve 198 shows the relative residual norm for a solution computed with preconditioning performed using 8-bit precision and the (1,4,3) format, and other computations performed at 64-bit precision.

As shown, solving with no preconditioning step was unsatisfactory because convergence was too slow. GMRES with preconditioning in FP64 converges the fastest, as the matrix-vector products with the approximate inverse preconditioners are computed in the greatest possible accuracy. Preconditioning using a low precision as discussed herein delivered substantially the same accuracy; however, the solution was computed much faster due to lower bandwidth and lower execution times.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk drive (HDD), a solid state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method of computation, comprising:
receiving, by a requesting device, a system of linear equations;
computing a solution to the system of linear equations by a flexible iterative algorithm, wherein the computing includes, for each iteration:
determining a most computationally expensive operation of the iteration,
mapping the most expensive operation to a low precision format, and
performing the most expensive operation according to a low precision;
performing other operations of the iteration according to a high precision; and
returning the solution to the requesting device.

2. The method of claim 1, wherein the solution is returned in a high precision format.

3. The method of claim 1, wherein the most computationally expensive operation is a preconditioning operation.

4. The method of claim 3, where the flexible iterative algorithm is configured to apply the preconditioning operation using one or more preconditioners having one or more variable parameters.

5. The method of claim 4, wherein the flexible iterative algorithm is a flexible Generalized Minimal Residual (GMRES) algorithm.

6. The method of claim 1, wherein the low precision is selected from at least one of a 4-bit precision and an 8-bit precision.

7. The method of claim 1, wherein the high precision is selected from at least one of a 16-bit precision, a 32-bit precision and a 64-bit precision.

8. The method of claim 1, wherein the most expensive operation is performed using a low precision hardware device, and the other operations are performed using a high precision hardware device.

9. A system comprising:
a memory device; and
one or more processing units coupled with the memory device, the one or more processing units are configured to perform a method of computation, the method comprising:
receiving, by a requesting device, a system of linear equations;
computing a solution to the system of linear equations by a flexible iterative algorithm, wherein the computing includes, for each iteration:
determining a most computationally expensive operation of the iteration,
mapping the most expensive operation to a low precision format, and performing the most expensive operation according to a low precision;
performing other operations of the iteration according to a high precision; and
returning the solution to the requesting device.

10. The system of claim 9, wherein the solution is returned in a high precision format.

11. The system of claim 9, wherein the most computationally expensive operation is a preconditioning operation.

12. The system of claim 11, where the flexible iterative algorithm is configured to apply the preconditioning operation using one or more preconditioners having one or more variable parameters.

13. The system of claim 12, wherein the flexible iterative algorithm is a flexible Generalized Minimal Residual (GMRES) algorithm.

14. The system of claim 9, wherein the low precision is selected from at least one of a 4-bit precision and an 8-bit precision, and the high precision is selected from at least one of a 16-bit precision, a 32-bit precision and a 64-bit precision.

15. The system of claim 9, wherein the most expensive operation is performed using a low precision hardware device, and the other operations are performed using a high precision hardware device.

16. A computer program product comprising a computer-readable memory that has computer-executable instructions stored thereupon, the computer-executable instructions when executed by a processor cause the processor to perform operations comprising:
receiving, by a requesting device, a system of linear equations;
computing a solution to the system of linear equations by a flexible iterative algorithm, wherein the computing includes, for each iteration:
determining a most computationally expensive operation of the iteration,
mapping the most expensive operation to a low precision format, and
performing the most expensive operation according to a low precision;
performing other operations of the iteration according to a high precision; and
returning the solution to the requesting device.

17. The computer program product of claim 16, wherein the solution is returned in a high precision format.

18. The computer program product of claim 17, wherein the most computationally expensive operation is a preconditioning operation, and the flexible iterative algorithm is configured to apply the preconditioning operation using one or more preconditioners having one or more variable parameters.

19. The computer program product of claim 16, wherein the flexible iterative algorithm is a flexible Generalized Minimal Residual (GMRES) algorithm.

20. The computer program product of claim 16, wherein the low precision is selected from at least one of a 4-bit precision and an 8-bit precision, and the high precision is selected from at least one of a 16-bit precision, a 32-bit precision and a 64-bit precision.
